(19) United States
(12) Patent Application Publication
(10) Pub. No.: US 2010/0258046 A1
(43) Pub. Date: Oct. 14, 2010

(54) Method and apparatus for suppressing cavitation on the surface of a streamlined body

(76) Inventors: Vladimir Berger, Hayward, CA (US); Sergey Sapronov, San Mateo, CA (US)

Correspondence Address: Vladimir Berger, 2237 Parnassus Court, Hayward, CA, 94542, US

(21) Appl. No.: 11/804,131

(22) Filed: May 17, 2007

(51) Int. Cl. B63B 1/24; F15D 1/10

(52) U.S. Cl. 114/274; 137/14; 137/825

(57) ABSTRACT

A method and a device for suppression of cavitation and thus for reducing resistance to movement of a streamlined body in a flow of liquid based on the principle that development of cavitation bubbles in the area of separation of the flow that is accompanied by the development of turbulence is prevented by injecting a gaseous medium into the aforementioned area for separating the flow of liquid from the surface of the streamlined body. The device of the invention can be realized in the form of various specific embodiments with supply of gas under pressure to the cavitation-development area through a plurality of perforations and transverse slits.

### FIELD OF INVENTION

The present invention relates to the field of hydrodynamics, in particular to suppressing cavitation on the surfaces of streamlined bodies operating in liquid media under conditions that may cause turbulence. In particular, the invention relates to hydraulic machines and devices such as hydraulic pumps, turbines, propellers, rudders, valves, or the like, the working elements of which may be subject to cavitations.

### BACKGROUND OF THE INVENTION

In order to better understand the principle of the present invention and to become familiar with the terminology, let us consider a relative movement between a streamlined body and a fluid, e.g., a liquid. In order to simplify the explanation, let us assume that the streamlined body having an oval longitudinal cross section is moving in a flow of liquid in the direction of the large axis of the oval cross section.

Although the explanation relates specifically to a substantially oval-shaped cross section, it should be noted that this shape has been selected arbitrarily and that the conclusions given below can be generalized for all bodies having smooth and streamlined surfaces, e.g., spheres, ellipsoids of revolution, bodies having flow-interaction areas limited by curved surfaces, e.g., surfaces of propellers, etc.

FIG. 1 shows a streamlined body 20 of a substantially oval longitudinal cross section which is described by an oval curve 22 and which is located in the flow of a liquid L, e.g., water W, moving in the direction of arrow A in the direction of a large axis 24 of the oval curve 22 with a velocity “v”. With a certain approximation, the model shown in FIG. 1 can be considered as a model of a hydrofoil. Therefore, the body 20 will be hereinafter referred to as a “hydrofoil”.

When the hydrofoil 20 moves in water with relatively low velocity, the flow of water that flows around the hydrofoil 20 along its surface is substantially laminar. In this case, the degree of turbulence is insignificant. As the speed of the hydrofoil 20 increases, the degree of turbulence of the flow also increases. This, in turn, leads to a nonlinear increase of the resistance to the movement of the hydrofoil 20 in water. In order to move the object (e.g., a vessel [not shown] to which the hydrofoil 20 is connected) at higher speeds, it is necessary to increase power of the propulsion means of the vessel. In this case, it will be required to increase power of the propulsor nonproportionally to the speed, i.e., at a higher rate than the speed. For example, if the speed of movement of the vessel constantly grows, propulsion power will be spent with constantly decreased efficiency.

Furthermore, the above-described scenario is accompanied by a phenomenon known as flow separation, or flow detachment, that occurs when the speed of flow (or the speed of the streamlined body relative to the liquid medium) reaches a predetermined critical value. This value depends on the shape of the object and parameters of the liquid, e.g., viscosity. More specifically, the liquid is unable to flow around the entire contour of the object in the trailing-edge area of the object profile, and this causes separation or detachment of the flow at this edge. If the object is a symmetrical body of the type shown in FIG. 1, then two zones of separation of the flow occur. These zones of separation are defined by flow separation lines, which in FIG. 1 are designated by reference numerals 26 and 28. Separation of the flow is accompanied by violation of flow laminarity and formation of gaseous microbubbles in the aforementioned zone. This phenomenon is known as cavitation, which is the subject of intensive studies. In FIG. 1, the cavitation zone that interacts with the trailing edge of the hydrofoil 20 is limited by a broken line, as shown by the dotted line 30. Although the mechanism of cavitation is beyond the subject of the present invention, a short explanation of this phenomenon is needed for better understanding the invention.

More specifically, a small space filled only with liquid vapors is formed in each point of the flow separation, as shown by lines 26 and 28. The pressure in these spaces depends on the properties of the liquid and its temperature, but, in general, the pressure is about −0.01 atm. In fact, these spaces are cavitation bubbles. Since the interiors of the bubbles are practically at vacuum, they instantly burst. In its nature, this burst is identical to an explosion into the bubble interior with an energy sufficient to knock out the finest pieces of the object material, in this case, of the hydrofoil. Thus, cavitation is able to destroy the hydrofoil or another object subject to this phenomenon to the extent of complete working disability.

Attempts have been made to eliminate or diminish the harmful effect of cavitation. In general, methods of suppressing cavitation can be divided into suppression of cavitation by optimization of the object profile and surface properties, dynamic suppression of cavitation by means of external factors, methods of changing properties of the liquid in the flow separation line area, etc.

For example, U.S. Pat. No. 6,846,365 published on Jan. 25, 2005 (inventor Madanshetty Sameer I) is an example of a method wherein cavitation is suppressed under the effect of an external factor, which in the illustrated case is acoustic energy of high frequency (the frequency of about 500 kHz) and high amplitude. A cavitation-preempting acoustic field in the liquid is similar in effect as using hyperbaric confinement for imposing hydrostatic pressure, a known method for suppressing cavitation. In this regimen, suppression of cavitation is caused by imposing a dominant high amplitude and a high-frequency pressure field to ensure that gaps between the compressive pulses are shorter than 10⁻⁷ to 10⁻⁶ seconds, which is less than that typically necessary to cause cavitation.

U.S. Pat. No. 6,699,008 published on Mar. 2, 2004 (inventor: D. Japikse) describes a device for at least partially stabilizing an unstable fluid flow within a flow channel by capturing at least a portion of the unstable fluid within a vaneless diffuser having a diffuser slot. The invention also includes maintaining and harnessing a substantial portion of the energy contained in the fluid as it flows through the diffuser in order to use the fluid to improve the condition of the flow field. An example includes discharging the diffuser effluent into the flow at other points critical to instability, hence reducing overall instability of the flow channel. In addition to applying a diffuser to the field of pumps, the same application can be made for centrifugal, mixed flow, and axial compressors, blowers, and fans.

Bentley Marine military propeller specialists and laboratory have developed a propeller of a new type that has from 4 to 6% better propulsive efficiency in the 30- to 60-Knot range when compared with the most modern propellers or water jets available. Depending on the type and dimensions of a yacht, this propeller may save up to 1,000 tons of fuel a year. The design features a 15% increase in diameter and reduced blade area. The elimination of cavitation reduces about twice the pressure pulse level at the hull skin, which translates to reduced hull vibration and increased comfort. The Cavitation Free Super Propeller may also be used on slow-speed displacement vessels with even greater efficiency.

US Patent Application Publication No. 20060225793 published on Oct. 12, 2006 (inventors: Bjarne Olsen, et al.) can be related to methods and devices wherein cavitation is reduced by chemical action on the treated liquid. The publication discloses a valve, especially for dosing inhibitors to prevent forming of hydrates in the exploration of oil and gas, or as a liquid choke. The inhibitor or liquid has a first and higher pressure upstream of the valve and a second and lower pressure downstream of the valve. The method proposed in this patent publication reduces the risk of cavitation by forming the inlet of the orifice with an enlarged diameter relative to the remaining part of the orifice. Consequently, pressure drop immediately after the inlet is avoided and the lowest pressure occurs at the outlet of the orifice. Preferably this is achieved by forming the inlet with a parabolic shape.

Russian Patent RU2260716 published on Oct. 6, 2005 (inventors A. Stepkin and Yu. Stepkina) describes a device aimed at reducing cavitation in hydraulic machines. The method precludes a break of liquid flow at the striking parts of hydraulic machines with a liquid by forming a controllable flow in near-the-boundary areas of hydraulic machines and increasing kinetic energy by imparting a rotating component to the flow in the direction of movement of the pump impeller. The device that reduces cavitation includes a section of a hydraulic machine pipeline.

However, the devices and methods described above are aimed at solving specific problems and therefore have narrow fields of application. In other words, none of the methods or devices described above possesses versatility sufficient for wide application in other fields beyond the specific use.

### OBJECTS AND SUMMARY OF THE INVENTION

It is an object of the present invention to provide a device and method for preventing cavitation on the trailing part that is a downstream part of the streamlined body in a flow of liquid. It is still a further object to provide a method of preventing cavitation that is versatile and that applies to various constructions such as propellers, hydrofoils, impellers, etc. It is another object to provide a method and device for suppressing cavitation without the use of such complicated methods as optimization of streamlined profiles or other geometrical changes of the object. A further object is to reduce resistance of a streamlined body to a flow of liquid under conditions of development of turbulence by preventing development of cavitation in the flow-separation area.

The method and device of the invention are based on the principle that development of cavitation bubbles in the area of flow separation that is accompanied by turbulence is prevented by supplying a gaseous medium under pressure into the aforementioned area in order to separate the flow of liquid from the surface of the streamlined body. The device of the invention is realized in the form of various specific embodiments. According to one embodiment, the flow of gas is supplied to the area that is at risk of developing cavitation through side channels that terminate at the flow separation line. According to another embodiment, the streamlined body is provided with a manifold for the supply of gas to the cavitation-development area be means of a plurality of perforations that terminate on the surface of the cavitation bubbles. In a further embodiment, the perforations are replaced by slits. In all embodiments, the flow of gas creates a continuous gaseous layer between the liquid and the surface on the trailing side of the streamlined body, which is at risk of cavitation-based deterioration.

Provision of the aforementioned gaseous flow protects the surface of the streamlined body from interaction with the separated flow. The viscous friction that normally occurs between the surface of a streamlined body and a liquid ceases to exist. As a result, a boundary layer that normally exists on the surface of the streamlined body on the line of separation of the flow is replaced by the artificially created gas layer. This excludes development of turbulence when the velocity of flow reaches a critical value. Suppression of turbulence, in turn, results in suppression of cavitation and decreases resistance to movement of the body in a liquid.

### BRIEF DESCRIPTION OF THE DRAWINGS

FIG. 1 is a longitudinal sectional view of a streamlined body in a flow of liquid under conditions of cavitation caused by turbulence.

FIG. 2 is a three-dimensional view of a hydrofoil of a vessel operating under the conditions shown in FIG. 1.

FIG. 3A is a longitudinal sectional view of a streamlined body equipped with a cavitation-suppressing system according to one embodiment of the invention.

FIG. 3B is a fragmental longitudinal view of the trailing part of the hydrofoil, illustrating side channels for the supply of the gaseous flow to the liquid-flow separation lines.

FIG. 3C is a fragmental longitudinal view of the trailing part of the hydrofoil, in which, in addition to the side channels of FIG. 3B, the hydrofoil body is provided with a longitudinal channels that terminate on the trailing edge of the hydrofoil body.

FIG. 4 is a three-dimensional view of a hydrofoil with a plurality of perforations on the trailing side for supplying gaseous flows that separate the flow of liquid from the surface on the trailing side of the hydrofoil.

FIG. 5 is a view similar to FIG. 4 that illustrates a hydrofoil wherein a plurality of transverse slits is used instead of perforations for the supply of gaseous flow to the trailing side of the hydrofoil for suppression of cavitation.

FIG. 6 is a view similar to FIG. 4 that illustrates a hydrofoil wherein several rows of perforations are used for the supply of gaseous flow to the trailing side of the hydrofoil for suppression of cavitation.

FIG. 7 is view similar to FIG. 4 that illustrates a hydrofoil wherein several transverse slits are used for the supply of gaseous flow to the trailing side of the hydrofoil for suppression of cavitation.

FIG. 8 is a top view of a hydrofoil provided with a manifold for the supply of gas flow to the perforations of the type shown in FIG. 6 or to the slits of the type shown in FIG. 7.

### DETAILED DESCRIPTION OF THE INVENTION

In the context of the present description, the term “a streamlined body in a flow of liquid” covers a condition wherein a relative movement exists between the liquid and the streamlined body, i.e., a stationary streamlined body may be located into a flow of a moving liquid, a streamlined body may move in a stationary liquid, or both the body and the liquid may participate in movements relative to each other.

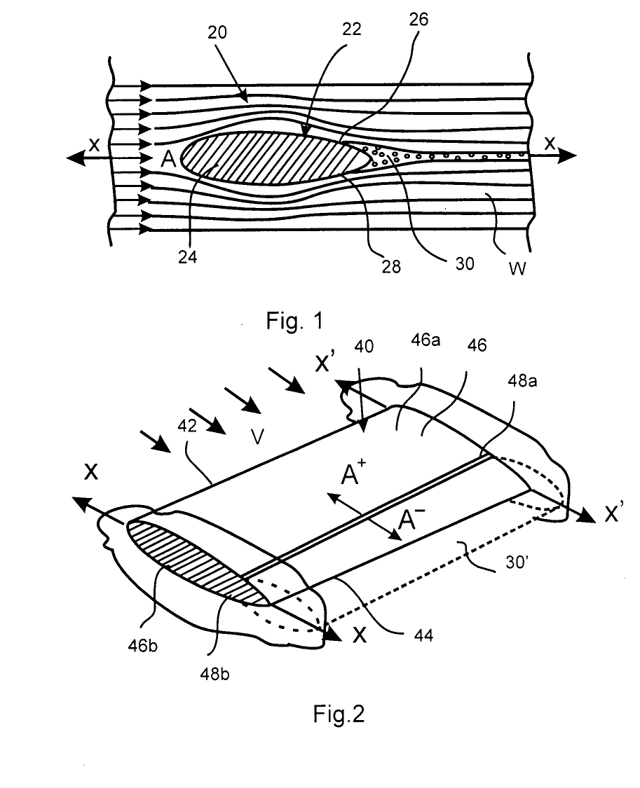

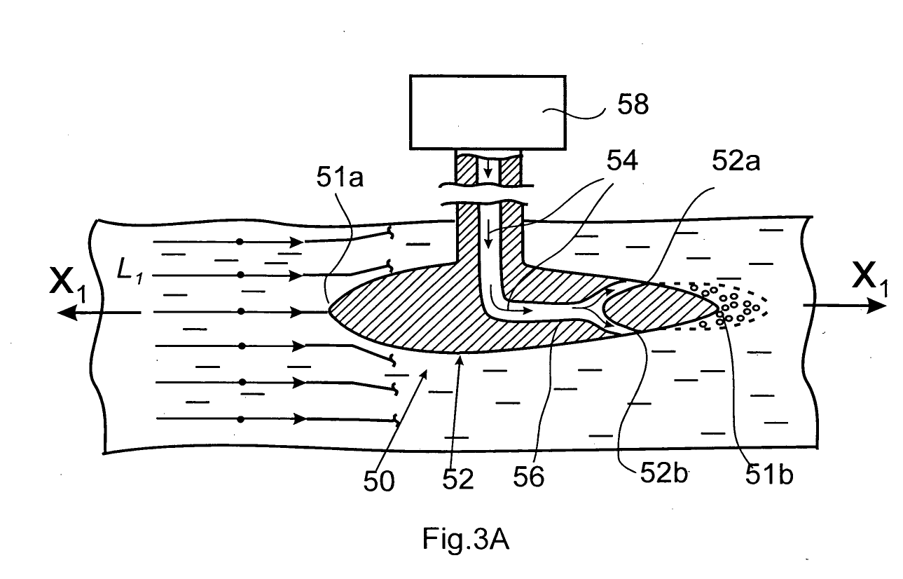

A three-dimensional view of a part of a conventional hydrofoil 40 of a vessel (not shown) moving in a liquid under conditions illustrated in FIG. 1 is shown in FIG. 2. In this drawing, reference numeral 42 designates the leading edge of the hydrofoil 40, and reference numeral 44 designates the trailing edge of the hydrofoil 40. The leading edge 42 and the trailing edge 44 are connected by the streamlined surface 46, which defines the streamlined profile of the hydrofoil 40 from above and below and which consists of a leading part 21 that confronts the flow of liquid and a trailing part 23 that contains the below-mentioned area of separation of flow.

Reference numerals 48a and 48b on the upper part 46a and the lower part 46b of the streamlined surface 46 designate flow-separation lines on which the flow of liquid L in which the hydrofoil works is separated from the surface of the hydrofoil when the latter operates under turbulent conditions. If we assume that the upper part 46a and the lower part 46b of the streamlined surface 46 are arranged symmetrically relative to the axis X-X that coincides with the direction of flow, then lines 48a and 48b also will be symmetrical relative to the axis X-X, i.e., will be located strictly one above the other.

Positions of the flow-separation lines 46a and 46b depend on the velocity “v” of the oncoming flow of the liquid L. More specifically, as the flow velocity “v” increases, the flow-separation lines 46a and 46b shift toward the leading edge 42 in the direction of arrow A⁺, and, when the flow velocity “v” decreases, the flow-separation lines 46a and 46b shift toward the trailing edge 42 in the direction of arrow A⁻. It is understood that when the flow velocity “v” drops to a certain limit, the flow-separation lines 46a and 46b coincide with each other on the trailing edge 44. This case corresponds to a completely laminar flow at which cavitation is practically absent.

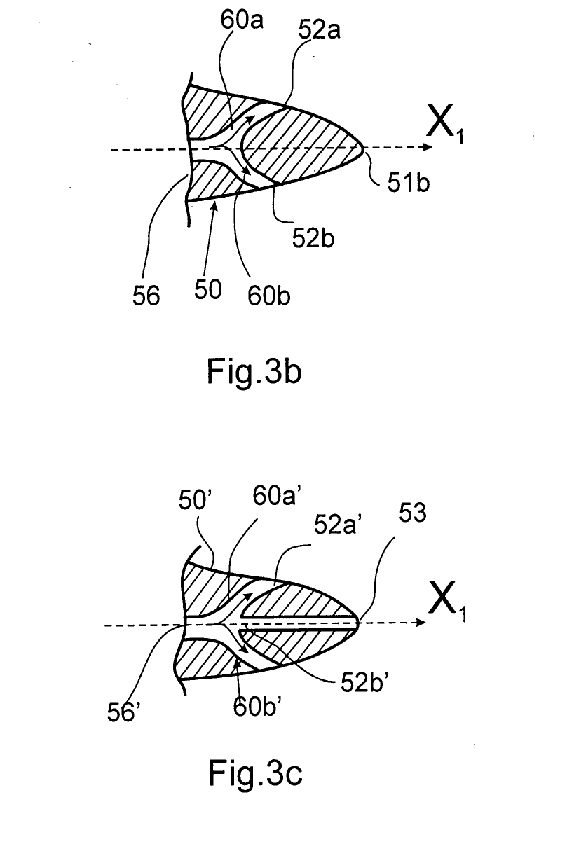

FIG. 3 is a schematic longitudinal view of a streamlined body of a hydrofoil 50 operating in a flow of liquid and equipped with a cavitation-suppressing system according to one embodiment of the invention. The principle of the invention realized in the embodiment of FIG. 3 is the prevention of cavitation bubbles in the area of the flow-separation lines 52a and 52b on the streamlined surface 52 of the hydrofoil 50. Turbulence that accompanies the separation of flow of the liquid L1 from the surface 52 of the hydrofoil 50 is prevented by injecting a flow 54 of a gaseous medium, e.g., air, which is supplied under pressure to an axial channel 56, which in the case of a symmetrical hydrofoil of the type shown in FIG. 3 coincides with the longitudinal axis X1-X1 parallel to the direction of the liquid flow.

The gas medium is supplied to the channel 56 from the source of a gaseous medium under pressure, e.g., an external source 58. This external source may comprise an air-intake device of the type used in a conventional internal combustion engine for supply of air to an air-fuel mixing device, or this external source may comprise a pump or a compressed-gas tank for positive supply of the gaseous medium under pressure.

FIG. 3B is a fragmental longitudinal view of the trailing part of the hydrofoil 50 of the embodiment of FIG. 3A with a positive supply of the gas medium. Reference numerals 51a and 51b designate the leading edge and the trailing edge of the hydrofoil 50, respectively. In this case, the axial channel 56 does not reach the trailing edge 51b and terminates at the entrance to side channels 60a and 60b which are branched from the axis channel 56. The side channels 60a and 60b are intended to supply the flow of gas to the liquid-flow separation lines 52a and 52b, respectively.

FIG. 3C is a fragmental longitudinal view of the trailing part of the hydrofoil, in which, in addition to the side channels 60a′ and 60b′, which are similar to the side channels 60a and 60b of FIG. 3B, the hydrofoil body 50′ is provided with a longitudinal channel 56′ that terminates on the trailing edge 53 of the hydrofoil body 50′. The channel arrangement of this embodiment is advantageous for use of an air-intake system without positively developed pressure, e.g., by a self-suction device.

Although the aforementioned streamlined body is shown as a substantially symmetric hydrofoil 50′ having two symmetrically arranged areas of separation of flow and two sets of the aforementioned channels 60a′ and 60b′, the body 50′ may be asymmetric or may have side channels only on one side.

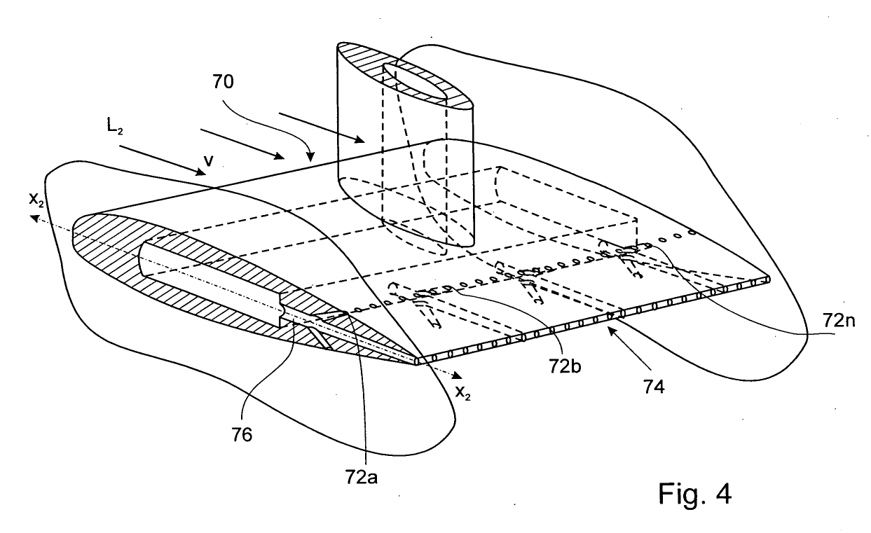

FIG. 4 is a three-dimensional view of a part of a hydrofoil body 70 with a plurality of perforations 72a, 72b, . . . 72n formed on the trailing side 74 of the hydrofoil body 70 for supplying the gas that separates the flow of the liquid L2 from the surface on the trailing side 74 of the hydrofoil body 70. The device is provided with a transverse manifold portion 76 which is formed in the hydrofoil body 70 in the direction perpendicular to the direction A3 of the flow of liquid L2. The gas may be supplied to the manifold 76 by channels arranged in accordance with the embodiments of FIG. 3B or FIG. 3C. In this case, two side channels 60a, 60b or 60a′, 60b′ are replaced by a plurality of side channels (only two of which, i.e., side channels 72a′ and 72b′, are seen in FIG. 3B). Each channel 72a′, 72b′, etc. terminates at respective perforations 72a, 72a′, 72b, . . . 72n on the trailing surface 78, i.e., on the flow-separation lines 80a and 80b. Reference numerals 82a, 82b, . . . 82n designate perforations that are arranged along the trailing edge 84 and that are connected to a continuous manifold 86 arranged perpendicular to the direction A3 of the flow of liquid L2. It can be seen from FIG. 4 that side channels 72a′ and 72b′ are branched from the manifold portion 76.

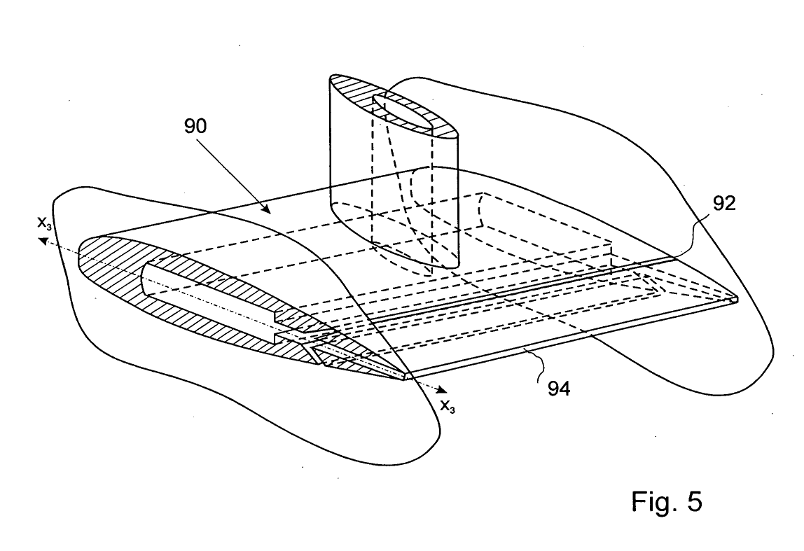

FIG. 5 is a view similar to FIG. 4, illustrating the part of a hydrofoil body 90 where a plurality (two in the illustrated case) of transverse slits 92, 94 is used instead of the perforations 72a, 72a′, 72b, . . . 72n for the supply of gas to the trailing side of the hydrofoil body 90 for suppression of cavitation. The rest of the construction is the same as in FIG. 4.

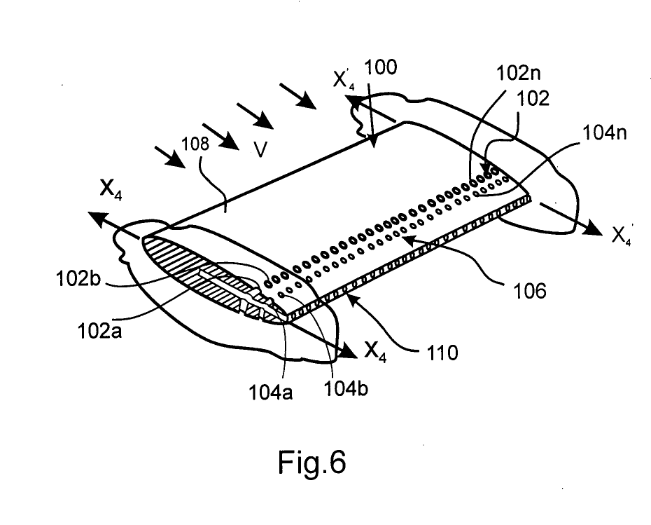

FIG. 6 is a view similar to FIG. 4, illustrating the part of a hydrofoil body 100 where several rows of perforations 102a, 102b, . . . 102n, 104a, 104b, . . . 104n, etc., are used to supply gas to the trailing surface 106 of the hydrofoil body 100 for suppression of cavitation. The gas supply system is the same as in the embodiment of FIG. 4. The perforations may exit to predetermined areas of the trailing surface of the hydrofoil 100 or may be spread over the entire trailing surface 106.

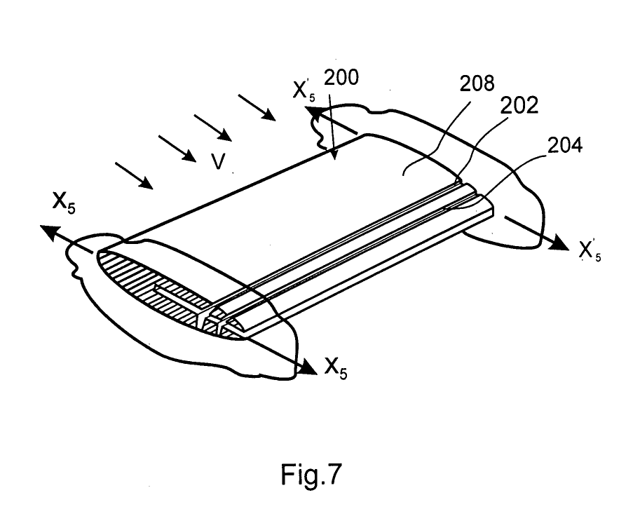

FIG. 7 is view similar to FIG. 4, illustrating the part of hydrofoil body 200 where several transverse slits 202, 204, 206, . . . are used for the supply of gas to the trailing surface 208 of the hydrofoil for suppression of cavitation. The rest of the system is the same as shown in FIG. 4.

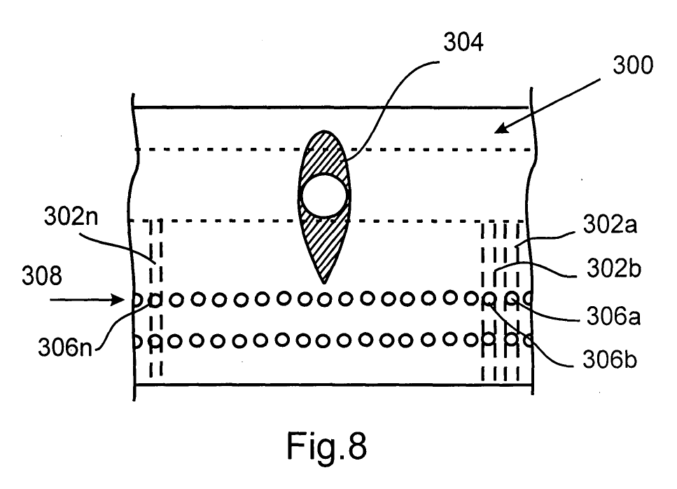

FIG. 8 is a top view of the part of a hydrofoil body 300 that illustrates by broken lines the arrangement of a plurality of side channels 302a, 302b, . . . 302n for the supply of gas from a central transverse manifold 304 to the perforations 306a, 306b, . . . 306n that terminate on the trailing surface 308 of the hydrofoil body 300.

Thus, it has been shown that the invention provides a device and a method for preventing cavitation on the trailing side of a streamlined body in a flow of liquid. The invention also provides a cavitation-suppressing method that is versatile and applicable to various constructions such as propellers, hydrofoils, impellers, valves, etc. Cavitation is suppressed without the use of complicated methods such as optimization of streamlined profiles or other geometrical changes of an object. The method and device of the invention reduce resistance of a streamlined body to the flow of liquid under turbulence by preventing development of cavitation in the flow-separation area.

Although the invention has been shown and described with reference to specific embodiments, it is understood that these embodiments should not be construed as limiting the areas of application of the invention and that any changes and modifications are possible, provided that these changes and modifications do not depart from the scope of the attached patent claims. For example, a streamlined body is not necessarily a hydrofoil but may be any other part or element that operates in a flow of liquid and is subject to development of cavitation, e.g., this can be a propeller, a turbine blade, an impeller blade, etc. The streamlined body is not necessarily symmetrical and may have an asymmetrical shape. The body may operate in liquids other than water. The streamlined body may be stationary and located in a flow of liquid, the liquid may be stationary and the streamlined body can move relative to the stationary liquid, or both the liquid and flow can move toward each other. The gaseous source may comprise a container with compressed gas, an air pump, or a self-suction air-intake device. Gas-supply channels and perforations may have arrangements different from those shown in the drawings and described in the specification. The cavitation suppression method of the invention can be used in combination with known methods. The device may be provided with a feedback link from the zone of development of cavitation to the source of supply of the gas medium for activation of the gaseous medium source only when turbulence occurs in the zone of separation of the flow.

1. A method for suppressing cavitation on the surface of a streamlined body operating in a flow of liquid under conditions at which turbulence may occur with development of cavitation in the area of separation of flow from the surface of the streamlined body, the method comprising the steps of: providing said streamlined body with means for supply of a gaseous medium under pressure to the area of separation of flow in order to separate the liquid from the surface of the streamlined body; and suppressing development of cavitation by supplying the gaseous medium under pressure to the aforementioned area for separating the liquid from the surface of the streamlined body.

2. The method of claim 1, wherein the means for supply of a gaseous medium under pressure comprise a source of a gaseous medium under pressure and channels formed in said streamlined body that connect the source of a gaseous medium under pressure with the aforementioned area of separation of flow from the surface of the streamlined body.

3. An apparatus for suppression of cavitation on the surface of a streamlined body operating in a flow of a liquid under conditions at which turbulence may occur with development of cavitation in the area of separation of flow from the surface of the streamlined body, the apparatus comprising:
a source of a gaseous medium under pressure; and
at least one channel that connects the aforementioned area of separation of flow from the surface of the streamlined body with the source of a gaseous medium under pressure for separating the liquid from the surface of the streamlined body.

4. The apparatus of claim 3, wherein the streamlined body has a leading part that confronts the flow of liquid, a trailing part that contains said area of separation of flow, and a trailing edge at the end of the trailing part, and where the aforementioned at least one channel is formed inside said streamlined body and has a side channel portion that goes directly to the area of separation of flow and beyond the trailing edge.

5. The apparatus of claim 3, wherein the streamlined body has a leading part that confronts the flow of liquid, a trailing part that contains said area of separation of flow, and a trailing edge at the end of the trailing part, and where the aforementioned at least one channel is formed inside said streamlined body and has a first portion that terminates at the trailing edge and has at least one side channel portion branched from the first portion and terminates at the area of separation of the flow of liquid.

6. An apparatus for suppression of cavitation on the surface of a streamlined body operating in a flow of a liquid under conditions at which turbulence may occur with development of cavitation in the area of separation of flow from the surface of the streamlined body, the streamlined body having a leading part that confronts the flow of liquid, a trailing part that is a downstream part of the streamlined body and that contains said area of separation of flow, and a trailing edge at the end of the trailing part, the apparatus comprising:
a source of a gaseous medium under pressure; and
channels that connect the aforementioned area of separation of flow from the surface of the streamlined body with the source of a gaseous medium under pressure.

7. The apparatus of claim 6, wherein the channels comprise a manifold portion that is formed in the streamlined body in the direction transverse to the direction of the flow and side channels branched from the manifold portion to the aforementioned area of separation of flow.

8. The apparatus of claim 7, wherein the source of a gaseous medium is a self-suction air-intake device and wherein the channels go from the manifold section directly to the area of separation of flow and beyond the trailing edge.

9. The apparatus of claim 7, wherein the manifold section is a continuous transverse channel and the side channels are a plurality of individual openings going from the continuous transverse channel to the aforementioned area of separation of flow and beyond the trailing edge.

10. The apparatus of claim 7, wherein the manifold section is a continuous transverse channel and the side channels are a plurality of transverse continuous slits going from the continuous transverse channel to the aforementioned area of separation of flow and beyond the trailing edge.

11. The apparatus of claim 6, wherein the aforementioned streamlined body is a substantially symmetrical hydrofoil having two symmetrically arranged areas of separation of flow and two sets of the aforementioned channels.

12. The apparatus of claim 7, wherein the aforementioned streamlined body is a substantially symmetrical hydrofoil having two symmetrically arranged areas of separation of flow and two sets of the aforementioned channels.

13. The apparatus of claim 8, wherein the aforementioned streamlined body is a substantially symmetrical hydrofoil having two symmetrically arranged areas of separation of flow and two sets of the aforementioned channels.

14. The apparatus of claim 9, wherein the aforementioned streamlined body is a substantially symmetrical hydrofoil having two symmetrically arranged areas of separation of flow and two sets of the aforementioned channels.

15. The apparatus of claim 7, wherein the source of a gaseous medium is a device with positive supply of a gaseous medium selected from the group consisting of a pump and a container with a compressed gas and wherein the channels have side channels that go from the manifold section directly to the area of separation of flow and a trailing edge channel that terminates at the trailing edge.

16. The apparatus of claim 15, wherein the manifold section is a continuous transverse channel and the side channels are a plurality of individual openings going from the continuous transverse channel to the aforementioned area of separation of flow.

17. The apparatus of claim 7, wherein the manifold section is a continuous transverse channel and the side channels are a plurality of transverse continuous slits going from the continuous transverse channel to the aforementioned area of separation of flow.

18. The apparatus of claim 15, wherein the aforementioned streamlined body is a substantially symmetrical hydrofoil having two symmetrically arranged areas of separation of flow and two sets of the aforementioned channels.

19. The apparatus of claim 16, wherein the aforementioned streamlined body is a substantially symmetrical hydrofoil having two symmetrically arranged areas of separation of flow and two sets of the aforementioned channels.

20. The apparatus of claim 17, wherein the aforementioned streamlined body is a substantially symmetrical hydrofoil having two symmetrically arranged areas of separation of flow and two sets of the aforementioned channels.

21. The apparatus of claim 18, wherein the aforementioned streamlined body is a substantially symmetrical hydrofoil having two symmetrically arranged areas of separation of flow and two sets of the aforementioned channels.
